(19) United States
(12) Patent Application Publication
(10) Pub. No.: US 2024/0159137 A1
(43) Pub. Date: May 16, 2024

(54) A FEED UNIT FOR FEEDING A CORE DRILL BIT INTO A WORK OBJECT

(71) Applicant: HUSQVARNA AB, Huskvarna (SE)

(72) Inventor: Andreas Jönsson, Hallsberg (SE)

(21) Appl. No.: 18/281,426

(22) PCT Filed: Mar. 10, 2022
(86) PCT No.: PCT/SE2022/050235

§ 371 Date: Sep. 11, 2023

(30) Foreign Application Priority Data
Mar. 11, 2021 (SE) 2150278-6

(51) Int. Cl. E21B 44/02; E21B 47/005; G06N 20/00

(52) U.S. Cl. CPC E21B 44/02; E21B 47/005; G06N 20/00; E21B 2200/20

(57) ABSTRACT

A feed unit (100) for feeding a core drill bit of a core drill system (190) into a work object, the feed unit comprising a feed motor (130) and a control unit (110), wherein the feed motor (130) is arranged to be mechanically connected to a device (194, 196) for feeding the core drill bit into the work object, and to be controlled by the control unit (110) via a motor control interface (120), wherein the control unit (110) is arranged to obtain a computer implemented classification model configured to classify a material engaged by the core drill bit into a pre-determined set of materials based on obtained data associated with the motor control interface, wherein the obtained data is indicative of a current and/or a voltage of the control interface, wherein the control unit is arranged to determine a material currently engaged by the core drill bit based on the classification model and the obtained data, and to control the feed motor based on the determined material.

### TECHNICAL FIELD

The present disclosure relates to core drill systems, and in particular to feed units for feeding a core drill bit into a work object. There are also disclosed methods and control units for automated or at least semi-automated feeding of a core drill bit into a work object and for classifying a material currently engaged by the core drill bit. The disclosed apparatuses and methods are advantageously implemented using machine learning methods, but can also be realized using classic signal processing techniques.

### BACKGROUND

Core drills are used for cutting hard materials such as concrete and stone. During operation, a drill bit, attached to a drilling machine, is rotated about an axle of rotation, and pushed into the material to be cut. The cutting segments on the drill bit provide an abrasive action as the drill bit is pushed into the material. A cylindrical ‘core’ is then cut out from the material, which core is received inside the drill bit. Thus, the name ‘core’ drill.

The drilling machine is normally attached to a drill stand arranged to guide the drill along a configurable drill path, i.e., at a pre-determined angle with respect to the material to be cut. The drill stand can be used to generate a drill bit pressure, or drill bit force, exerted by the cutting segments on the material which is abraded by pushing the core drill bit into the material to be cut. The force can be automatically controlled by an automatic feed unit or manually by an operator using a feed mechanism, such as a crank.

Current automatic feed units, however, are limited in their level of autonomy. Therefore, there is a need for improved automatic feed units.

There is also a desire to simplify the overall core drilling process and to provide core drilling systems which can be used by more inexperienced operators.

There is furthermore a desire to provide feed units which reduce the wear on the core drill bit during operation of the core drilling system.

### SUMMARY

It is an object of the present disclosure to provide improved feed units for core drilling which alleviate at least some of the above-mentioned issues.

This object is at least in part obtained by a feed unit for feeding a core drill bit of a core drill system into a work object. The feed unit comprises a feed motor and a control unit. The feed motor is arranged to be mechanically connected to a device for feeding the core drill bit into the work object, and to be controlled by the control unit via a motor control interface. The control unit is arranged to obtain a computer implemented classification model configured to classify a material currently engaged by the core drill bit into a pre-determined set of materials based on obtained data associated with the motor control interface, wherein the obtained data is indicative of a current and/or a voltage of the control interface. The control unit is also arranged to determine a material currently engaged by the core drill bit based on the classification model and the obtained data, and to control the feed motor based on the determined material currently engaged.

This way an increased level of autonomy is enabled, since the control unit is now aware of the material currently engaged by the core drill bit. The pre-determined set of materials may for instance comprise air and one or more work object materials such as different types of concrete, stone, and marble. The pre-determined set of materials optionally also comprises one or more different work object material compositions and/or levels of concrete maturity, such as different concrete recipes and degrees of concrete maturity. This information may, for instance, allow adjustment of the feed motor control in order to optimize the drilling process.

The object is also at least in part obtained by a feed unit for feeding a core drill bit of core drill system into a work object. The feed unit comprises a feed motor and a control unit. The feed motor is arranged to be mechanically connected to a device for feeding the core drill bit into the work object, such as a drill stand with a mounting device or the like. The feed motor is arranged to be controlled by the control unit via a motor control interface. The control unit is arranged to obtain a computer implemented classification model, wherein the classification model is configured to classify a current drilling stage of the core drill system into a pre-determined set of drilling stages primarily based on obtained data indicative of a current and/or a voltage of the control interface and generally associated with the motor control interface. The control unit is furthermore arranged to determine a current drilling stage of the core drill system based on the classification model and on the obtained data, and to control the feed motor based on the determined drilling stage to perform a drilling operation.

The technique of determining drilling stage is of course tightly related to the technique of determining which material that is currently engaged by the core drill bit. When the core drill bit engages air, the drilling stage is either a nominal drilling stage before the work object is engaged, or a drilling stage after the core drill bit has exited the work object on the other side, indicating completion of the drilling process. Engagement by the core drill bit with a metal reinforcement bar structure can also be considered a drilling stage since the feed force may be adjusted during this stage in order to optimize the drilling process. For instance, it may be advantageous in terms of drilling efficiency and tool wear to adjust the feed force as the core drill bit drills through the metal reinforce bar material, such as reducing the feed force.

According to aspects of the herein disclosed techniques, the control unit of the feed motor is arranged to receive control commands from a remote device such as a remote server and/or a remote control device, and to adjust these commands in dependence of a determined current drilling stage and/or in dependence of a determined material currently engaged by the core drill bit. This way the control unit may adjust, e.g., reduce, a force applied to the core drill bit when reinforcement bar material is encountered, or when the core drill bit exits the work object on the far end, i.e., when the drilling operation has completed.

An advantage of the disclosed feed units is that they do not have to be connected to the core drill system other than via the mechanical connection between the feed motor and the device for feeding the core drill bit into the work object. In other words, there is no need for an electrical connection or some sort of data connection between the drill and the feed unit, wired or wireless. There is also no need to power the feed unit and the drilling machine from the same power source, and there is no need for sending complex and error-prone communication signals between the feed unit and the drilling machine. The lack of connections other than the mechanical one makes the disclosed feed unit easy to install and to operate, and it will be backwards compatible with existing core drill systems without the need for any modifications, which is an advantage.

The disclosed control of the feed motor enables an improved autonomous operation, which in turn makes the whole drilling operation more efficient. The disclosed feed unit can handle many different scenarios with little manual input, which makes the drilling operation easier to handle, especially for inexperienced core drill operators. Despite all of these advantages, the disclosed feed unit does not require any costly parts. It is an advantage that the detection mechanisms can be based primarily on computer implemented methods using the motor current and/or voltage and does not need other sensor systems. However, implementations using vibration data and/or sound captured by sensors in connection to the feed unit has also been shown to yield satisfactory results. Thus, the motor current and/or voltage data from the motor interface is not always necessary to obtain in order to realize the herein disclosed techniques.

The stages in the pre-determined set of drilling stages may together form a drilling operation. The control unit determines a current drilling stage of the core drill system out of a pre-determined set of drilling stages. The current drilling stage is the stage the core drill system is currently in, and the pre-determined set of drilling stages comprises a number of predefined stages that the core drill system can be in.

The control unit is arranged to control the feed motor based on the determined drilling stage. This means that drill bit is fed into the work object or retracted away from the work object, i.e., the drill bit pressure is increased or decreased, based on which stage the drill bit is determined to be in and/or based on the material determined to be currently engaged by the core drill bit.

According to aspects, the computer implemented classification models discussed herein are arranged to classify a state of the core drill system into a pre-determined set of states comprising one or more fault states based on the obtained data. In that case, the control unit is arranged to determine a state of the core drill system out of the pre-determined number of states based on the classification model and based on the obtained data, and to control the feed motor based on the determined state. Thus, advantageously, fault conditions can be automatically detected, and a suitable response action can be triggered by the control unit. For instance, a damaged core drill bit may warrant an immediate abortion of the drilling procedure. This feature can be implemented independently of the features of detecting material currently engaged and also independently of the features related to detecting drilling stage. The feature can also be realized using data other than data associated with the motor interface, such as sensor data comprising vibration and/or sound captured in connection to the feed unit.

According to aspects, the computer implemented classification model is configured to classify a material composition of the work object into a pre-determined set of material compositions based on the obtained data. The control unit is thus arranged to determine a material composition based on the classification model and the obtained data, and to control the feed motor based on the determined material composition.

This allows the system to adjust its operation to better suit a given work object material composition, which improved the overall drilling efficiency.

According to aspects, the computer implemented classification model is configured to classify or determine a drill bit force of the core drill based on the obtained data. The control unit is thus optionally arranged to determine a drill bit force applied to the core drill bit based on the classification model and on the obtained data, and to control the feed motor based on the determined drill bit force. This enables a more efficient operation of the core drill system since a feedback loop is established between the feed motor control and the actual applied drill bit pressure. This feature can also be implemented independently of the features of detecting material currently engaged and also independently of the features related to detecting drilling stage.

According to aspects, one drilling stage in the pre-determined set of drilling stages is an unknown drilling stage, i.e., a drilling stage which could not be identified/classified with enough certainty by the control unit. The control unit may, upon determining that the current drilling stage is an unknown drilling stage, proceed to control the feed motor to return the core drill bit to a start position. Alternatively, the control unit may simply stop the feed motor in case no accurate drilling stage classification can be made. This feature increases system safety. A similar feature can also be implemented where the control unit determines that an unknown material has been encountered by the core drill bit. The drilling operation can then be aborted in response to detecting that the core drill bit has engaged the unknown work object material.

According to aspects, the control unit is arranged to control the feed motor such that the drill bit force applied to the core drill bit is below a predetermined maximum force. This way, the drilling operation can be executed in a safe manner, and not exceeding the predetermined maximum force. The predetermined maximum force can be adapted in dependence of the material currently engaged by the core drill bit. This is an advantage since different materials have their optimum associated drill bit pressures. The force applied to a core drill bit which encounters a reinforcement bar structure is for instance preferably reduced until the reinforcement bar structure has been penetrated, which improves the drilling efficiency and also reduces tool wear in many cases.

According to aspects, the control unit is arranged to control the feed motor based on a tangential velocity associated with the drill bit. The feed unit can thus avoid operating the drilling machine at combinations of tangential velocity and drill bit force where there is a risk of glazing the abrasive segments. This way the risk of segment glazing is reduced. The tangential velocity can of course also be adjusted in dependence of which material that is currently engaged by the core drill bit. Look-up tables can be pre-configured with suitable combinations of drill bit force and tangential velocity for each detected work object material.

According to aspects, the tangential velocity associated with the drill bit is measured by an angular rate sensor comprised in the feed unit. This additional sensor data acts as a complement which further increases the performance of the proposed methods in terms of detection performance.

According to aspects, the obtained data further comprises measured vibration of the feed unit, wherein the vibration is measured by an inertial measurement unit (IMU) comprised in the feed unit. This additional sensor data further increases the classification performance. For instance, the completion drilling stage may give rise to a signature vibration pattern which can be picked up by the machine learning algorithm and used for classification of the current drilling stage. Different materials currently engaged by the core drill bit also give rise to signature vibration patterns. It is noted that some realizations of the techniques discussed herein rely solely on vibration data for the feed motor control, i.e., it is possible to base a feed unit control system solely on vibration data.

According to aspects, the obtained data further comprises sound measured around the feed unit, wherein the sound is measured by an acoustic sensor comprised in the feed unit. This additional sensor data further increases the classification performance. It is also noted that some realizations of the techniques discussed herein rely solely on sound data for the feed motor control, i.e., it is possible to base a feed unit control system solely on sound data or on a combination of vibration data and sound data.

According to aspects, the feed motor and the control unit are integrally formed and enclosed by a common casing.

According to further aspects, the feed unit comprises an electrical storage system, such as a battery or fuel cell, where the feed motor and the control unit are arranged to be powered by the electrical storage system. This provides a unit that is easily assembled in a core drill system.

According to aspects, the control unit is arranged to transmit any of the obtained data, information indicative of the current drilling stage and/or material currently engaged by the core drill bit, and the current controlling of the feed motor to a data collection entity arranged external to the feed unit. The control unit may also be arranged to receive the classification model and/or instructions for controlling the feed motor in dependence of the current drilling stage from an external entity. By training the classification model in an external entity, more processing power can be exploited. The power tool normally does not comprise the amount of processing power required for detailed training and verification of fault models for these purposes. The external entity which is involved in this type of information exchange may for instance be a remote server and/or a remote control device. It is appreciated that particular advantages are obtained by feeding information related to current drilling stage and/or the material currently engaged by the core drill bit to a remote control device, since this allows the operator to better monitor the drilling process, and perhaps intervene if something unexpected occurs.

According to aspects, the classification models have been trained using recorded values of the obtained data corresponding to different drilling stages of the core drill system in the pre-determined set of drilling stages and/or corresponding to different materials currently engaged by the core drill bit. Thus, the classification model is adjusted to the specific type of use case of interest, i.e., to a specific tool or work task. This enables a more efficient and accurate classification of the current drilling stage and also facilitates the determination of the material currently engaged by the core drill bit.

According to aspects, the obtained data comprises D-Q transformed motor currents of the feed motor. A D-Q transformed motor current is easily measured and is often already conveniently available in existing electric motor control systems. Thus, the methods disclosed herein can be implemented as a software add-on in existing power tool control units.

According to aspects, the D-Q transformed motor currents of the obtained data comprises any of frequency width, relative magnitude, frequency sub-band power, and frequency sub-band entropy of a Fourier transformed representation. This type of meta-data can be determined without prohibitive computational complexity and has been shown to provide accurate classification.

According to aspects, the classification model is based on a random forest ensemble learning method. The random forest ensemble learning method has been shown to provide adequate detection performance despite sometimes having limited amounts of measurement data available.

According to aspects, the classification model is based on a neural network. A neural network, once properly configured and trained, provides excellent classification performance for these types of applications.

The classification model is not necessarily based on machine learning or techniques related to artificial intelligence. Rather, it is appreciated that the computer implemented classification models discussed herein can also be based on classic signal processing techniques where one or more parameters are determined based on the obtained data, and then compared to predetermined ranges or thresholds. The classification of material currently encountered by the core drill bit, and/or the current drilling stage of the core drill system, can then be determined based on the parameter values in this manner. Example parameters which can be used in this manner will be discussed below.

According to aspects, the classification model is configured in dependence of a particular type of core drill system. This way the classification can be tailored to a specific type of tool, which improves detection performance in many scenarios.

There are also disclosed methods and control units associated with the same advantages as discussed above in connection to the different apparatuses.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 shows an example core drill system;

FIG. 2 schematically illustrates a general electric motor control system;

FIG. 3 schematically illustrates a three-phase electric motor control system based on an inverter;

FIG. 4 is a functional view of an example tool control system;

FIG. 5 schematically illustrates an automated classification system;

FIG. 6 illustrates a classification data collection system;

FIGS. 7A and 7B are graphs showing undesired operating regions;

FIG. 8 shows an example of a warning display;

FIGS. 9A-B are flow charts illustrating methods;

FIG. 10 schematically illustrates a control unit;

FIG. 11 schematically illustrates a computer program product;

FIG. 12 is a graph illustrating meta data extracted from measurement data; and

FIGS. 13A-B show an example core drill system.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

It is appreciated that, although the techniques and concepts disclosed herein are mainly exemplified using a core drill, the techniques are in no way limited to this type of drill. The herein disclosed techniques can be applied to a wide range of rotatable work tools, such as other types of drills, lathes, and the like where a work tool is attached to a rotating spindle to rotate about a central axis, and which may utilize a unit for automatic feeding of the work tool into or at least relative to a work object.

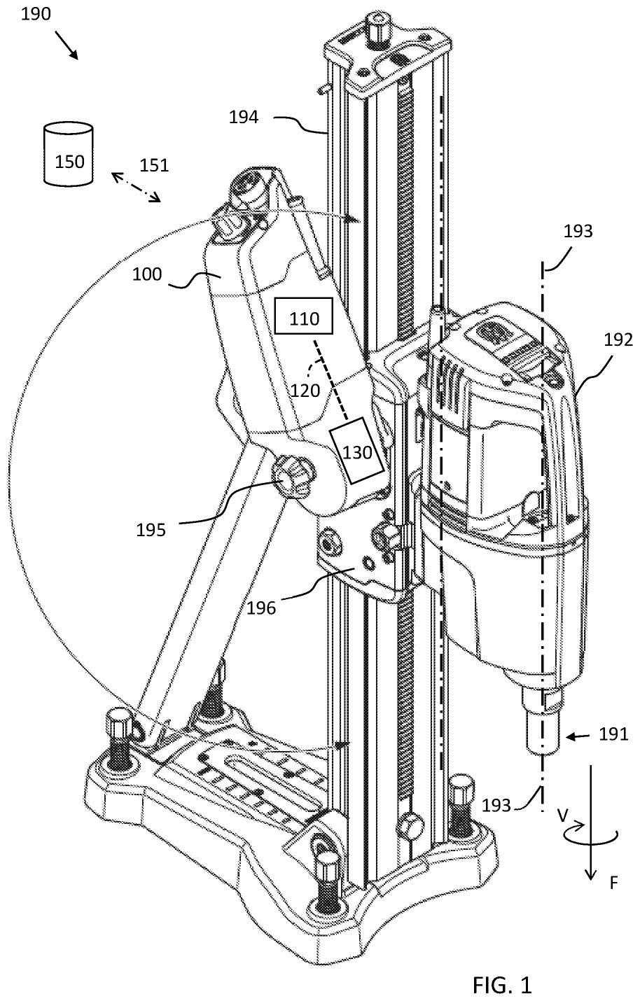

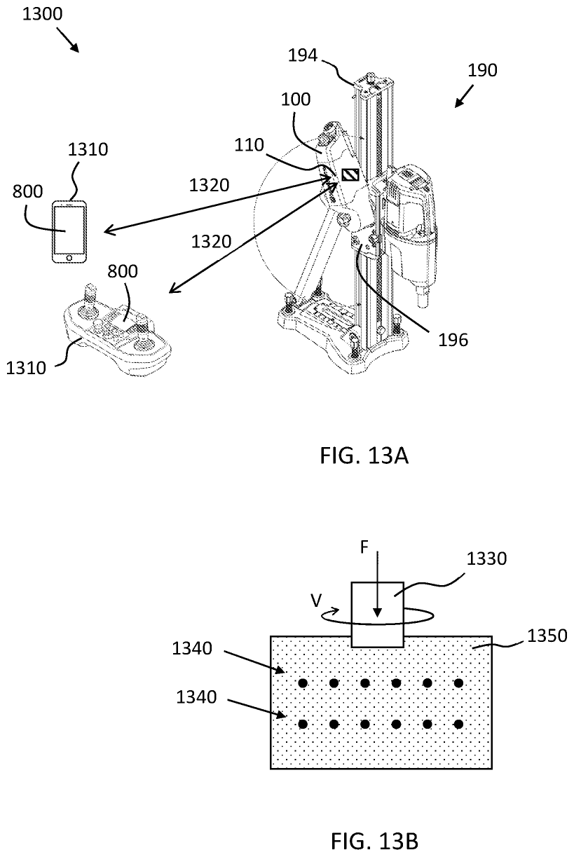

FIG. 1 shows a core drill system 190 for cutting hard materials such as concrete and stone by a core drill bit (schematically illustrated in FIG. 13B). The core drill bit is powered by a drilling machine 192 comprising a drill motor arranged to power a spindle in a known manner. The drill bit is attached to the spindle via a drill bit interface 191.

During operation, the drill bit is rotated about an axle of rotation 193 and pushed into the material to be cut, i.e., the work object. The cutting segments on the drill bit provide an abrasive action as the drill bit is pushed into the material. A cylindrical ‘core’ is then cut out from the material, which core is received inside the drill bit. Thus, the name ‘core’ drill.

The drilling machine is normally attached to a drill stand 194 arranged to guide the drill along a configurable drill path, i.e., at a pre-determined angle with respect to the material to be cut. In FIG. 1, the drill stand 194 comprises a mounting device 196 that holds the drilling machine and that is arranged to traverse a pillar in a downwards and in an upwards direction to and from the work object, respectively. The drill stand 194 can be used to generate a drill bit pressure, or drill bit force F, exerted by the cutting segments on the material which is abraded by pushing the core drill bit into the material to be cut. In FIG. 1, a feed unit 100 is arranged to control the feeding of the core drill and thereby the force F. The force F is normally measured in Newtons (N) or equivalently as a torque in Nm applied at a mounting point 195 where the feed unit 100 is mounted to the drill stand 194.

Core drill systems 190, i.e., the drilling machine 192 and the drill bit, and equipment such as the drill stand 194, such as that shown in FIG. 1, are known in general and will therefore not be discussed in more detail herein.

As mentioned above, there is a need for improved feed units. Therefore, there is disclosed herein a feed unit 100 for feeding a core drill bit of a core drill system 190 into a work object. The feed unit comprises a feed motor 130 and a control unit 110.

The feed motor 130 is arranged to be connected to a device for feeding the core drill bit into the work object, such as the drill stand 194 with the mounting device 196 in FIG. 1 or some other form of device for feeding the core drill bit into a work object. The feed motor 130 is arranged to be controlled by the control unit 110 via a motor control interface 120. The control unit 110 is arranged to obtain a computer implemented classification model configured to classify a current drilling stage of the core drill system 190 into a pre-determined set of drilling stages based on obtained data associated with the motor control interface 120 which is indicative of a current and/or a voltage of the control interface 120, i.e., it indicates how the feed motor is operating. The obtained data upon which the control unit operation is based can alternatively or as a complement also based on some form of sensor data captured in connection to the feed unit, such as vibration and/or sound data. The control unit is arranged to determine a current drilling stage of the core drill system 190 based on the classification model and based on the obtained data, and to control the feed motor 130 based on the determined drilling stage. The feed unit can be operated in a stand-alone manner as an automatic feed unit, or as a semi-automatic feed unit which receives control commands from a remote control device, which will be discussed in more detail below in connection to FIG. 13A.

The control unit 110 may also be arranged to obtain a computer implemented classification model configured to classify a material currently engaged by the core drill bit into a pre-determined set of materials based on the obtained data associated with the motor control interface 120 and/or based on sensor data captured in connection to the feed unit, such as sound and vibration data. This allows the control unit 110 to determine a material currently engaged by the core drill bit based on the classification model and the obtained data, and to control the feed motor 130 based on the determined material. It is appreciated that the control unit may determine the material currently engaged by the core drill bit independently from the determining of the current drilling stage, although the two determinations are advantageously performed in parallel since they complement each other. Several aspects of the herein disclosed techniques will be discussed below. It is appreciated that most, if not all, of these various aspects can be performed independently of the other aspects, and normally also in a stand-alone manner without any dependency on other features.

Advantageously, the feed motor 130 may be formed electrically separate from the drill motor of the drilling machine 192. In FIG. 1, the drill motor is arranged to power a spindle of the drilling machine and the feed motor is arranged to feed the drill into a work object by having the mounting device 196 climb up and down teeth on a pillar of the drill stand 194. The feed motor may be connected to the device 196 for feeding the core drill into the work object directly or via some transmission arrangement based on a drive belts, gear, and such.

One advantage of the disclosed feed unit 100 is that it does not have to be connected to the core drill system 190 other than via the mechanical connection of the feed motor 130 to the device for feeding the core drill bit. In other words, there is no need for an electrical connection, wired or wireless, between the feed unit 100 and the drilling machine 192. There is no need to power the feed unit 100 and the drilling machine 192 from the same power source, and there is no need for sending communication signals between the feed unit and the drilling machine. The lack of connections other than the mechanical one makes the disclosed feed unit 100 easy to install and operate, and it will be compatible with existing core drill systems 190 without the need for any modifications. However, embodiments of the disclosed feed unit 100 may of course be complemented with other connections, e.g., for redundancy purposes. One such example is the connection to the remote device, i.e., the server or remote control device. Information about the drilling process determined at the feed unit may be useful both at the remote server and at a remote control device configured to send control commands to the feed unit. For instance, the remote control device may comprise a display which indicates a current material engaged by the core drill bit, such as if the core drill bit is engaging a concrete section of the work piece or if the core drill bit is currently engaged in drilling though a metal reinforcement bar structure.

Completion of the drilling process can also be useful to display at the remote control device.

The stages in the pre-determined set of drilling stages together form at least parts of a drilling operation. The drilling operation can include starting to feed the drill bit into the work object from a starting position, e.g., above a work object, continuously feeding the drill bit into the work object, and returning the drill bit to the starting position when the drilling is finished. This example drilling operation can be divided into three drilling stages: a startup drilling stage, a concurrent drilling stage, and a completion drilling stage. The control unit 110 determines the current drilling stage of the core drill system 190 from a pre-determined set of drilling stages. The current drilling stage is the stage the core drill system is currently in, and the pre-determined set of drilling stages comprises a number of predefined possible stages that the core drill system can be in. In an example embodiment, the concurrent drilling stage is dynamic, i.e., the control unit constantly, or periodically at some time interval, updates the classification of the current drilling stage and thereby updates the control of the feed motor. The completion stage can comprise drilling through the work object, e.g., a wall. When the core drill has drilled through the work object, the control unit may determine that the current drilling stage is the completion stage, and thereafter automatically change the feeding accordingly, e.g., by returning the core drill bit to the starting position.

According to aspects, one drilling stage in the pre-determined set of drilling stages is an unknown drilling stage. The control unit may, upon determining that the current drilling is unknown, proceed to control the feed motor to return the core drill bit to a start position. Alternatively, the control unit may simply stop the feed motor. The unknown drilling stage can be a stage into which the classification model classifies the current drilling stage if it cannot place the current drilling stage into any other stage with enough certainty. For example, if there are three “normal” stages in a drilling operation, and if the classification does not result in the determined current drilling stage being any of the three with a predetermined level of certainty, the control unit may determine that the current drilling stage is an unknown drilling stage. A predetermined certainty can, e.g., mean to be within a predetermined confidence interval. The actual classification operation will be described and exemplified in more detail below.

The control unit is arranged to control the feed motor based on the determined drilling stage. This means that drill bit is fed into the work object or fed away from the work object with a force in dependence of the drilling stage, i.e., the drill bit pressure is increased or decreased, based on which stage the drill bit is determined to be in. The control of the feed motor based on the determined drilling stage can be to complete a defined drilling operation automatically based on a current work status during the operation.

The core drill system 190 may suffer a variety of different fault states or fault conditions, such as different types of malfunction and reasons for reduced performance. For instance, one or more of the cutting segments attached to the drill bit may detach during operation, or at least partially break. A system with a damaged drill bit is normally associated with a reduced performance. Such damaged cutting implements may also pose a risk to an operator since the risk of undesired seizing events and the like may increase. There is also a risk that the work object being cut may become damaged during operation, which of course is undesired.

To account for such events and to mitigate associated risks, the feed unit 100 can be prepared to automatically control the feeding of the drill bit during various fault events. In other words, the computer implemented classification model may further be arranged to classify a state the core drill system 190 into a pre-determined set of states comprising one or more fault states based on the obtained data. In that case, the control unit is arranged to determine a state of the core drill system into the pre-determined number of states based on the classification model and the obtained data, and to control the feed motor 130 based on the determined state. Thus, advantageously, fault conditions can be automatically detected, and a suitable response action can be trigged by the control unit. One example of suitable response action can be to simply turn off the feed motor 130. Another action can be to retract the core drill bit to a start position in a controlled manner. Yet another action can be to trigger a warning signal of some sort to alert an operator about the fact that a fault condition has occurred, for instance by sending a message to the remote control device in case the feed unit is a remote controlled feed unit. Alternatively, the abnormal drilling stage can comprise several different identifiable stages outside the desired drilling operation, such as different fault states or fault conditions. Fault conditions can be different types of malfunction and reasons for reduced tool performance, such as the drill bit breaking, motor or transmission malfunction, a seized bearing, an overheated machine part etc.

The feed unit may also be a remote controlled feed unit, i.e., the control unit 110 may be arranged to receive control commands for controlling the feed motor 130 from a remote control device 1310 as illustrated in FIG. 13A which shows a concrete processing system 1300 comprising the core drill system 190. In this case the feed unit may adjust the control commands received over wired or wireless link 1320 from the remote control device 1301 in dependence of the current drilling stage and/or in dependence of the material currently engaged by the core drill bit to optimize the drilling process. For instance, with reference to FIG. 13B, the applied force F to the core drill bit and/or the tangential velocity V of the core drill bit can be adjusted if a reinforcement bar structure 1340 in the work object 1350 is encountered, even if the control command received from the remote control device 1310 remains unchanged. The operation can of course also be aborted despite the control commands received from the remote control device, for instance in case an unknown drilling stage is detected, or an unknown material is encountered during the drilling process. This way the feed unit implements a type of safety function which is arranged to over-ride the control commands received from a remote control device.

The techniques disclosed herein can as mentioned above also be used to classify a material currently engaged by the core drill bit into a pre-determined set of materials based on the obtained data associated with the motor control interface 120. The control unit 110 is then arranged to determine the material currently engaged by the core drill bit based on the classification model and the obtained data. The feed motor can be controlled in dependence of the material currently engaged, i.e., if the core drill bit is encountering air prior to commencing a drilling operation stage, or after the drilling is complete and the core drill bit has exited the work object on the other side.

The feed motor operation can also be adjusted as the core drill bit initially engages the work object, and also as the core drill bit encounters differences in material composition, or other materials in the work object such as metal reinforcement bars as it traverses the work object. The pre-determined set of materials may just comprise air and a general work object material. However, the work object material may also be further specified into different types of work object material, i.e., the classification may also involve work object material composition such as different concrete recipes. Concrete maturity level, i.e., how far the concrete has come in its maturity process from the time of pouring may also be valuable to determine in order to adjust the feed force in a suitable manner. To summarize, there is disclosed herein a feed unit 100 for feeding a core drill bit of a core drill system 190 into a work object. The control unit 110 is arranged to obtain a computer implemented classification model configured to classify a material currently engaged by the core drill bit into a pre-determined set of materials based on obtained data associated with the motor control interface 120. The control unit 110 is arranged to determine the material currently engaged by the core drill bit based on the classification model and the obtained data, and to control the feed motor 130 based on the determined material.

It may be desirable for the automatic drilling to behave differently depending on the material of the work object. For example, the drill bit force F may advantageously be set differently for different types of concrete, different levels of concrete maturity, and for other materials such as if reinforcement bar steel is encountered somewhere along the drilling process. Therefore, the computer implemented classification model may be configured to classify a material composition and/or degree of concrete maturity of the work object out of a pre-determined set of material compositions and/or concrete maturity levels based on the obtained data. The control unit 110 can then be arranged to determine a material composition based on the classification model and the obtained data, and to control the feed motor 130 based on the determined material composition. The control unit may automatically detect a different material during the concurrent stage and then change the feeding accordingly. For example, when drilling into a concrete slab, the control unit can detect if there is steel present in the middle of the slab and increase the drill bit force when drilling the steel, and then return to the previous settings when the steel is drilled through. Other types of customization in dependence of the material composition are of course also possible.

The machine may also be able to detect when the core drill bit has penetrated through the work object, i.e., detect when the core drill bit starts to engage air again after having engaged a work object material. As the drill bit progresses through the different stages of drilling, the amount of water added to the drilling zone can be adjusted. For instance, the water may be turned off automatically when the core drill bit penetrates the work object. Also, the flow of water may be increased when the core drill bit hits a material associated with high temperatures in the drill bit, such that the drill bit is more efficiently cooled. This automatic adjustment of the amount of added water means that the water is used more efficiently during the grinding process, which may reduce a total amount of water used during the drilling operation.

According to aspects, with reference to FIG. 1, the computer implemented classification model is configured to classify the drill bit force F of the core drill based on the obtained data, and the control unit 110 may be arranged to determine the drill bit force F applied to the core drill bit based on the classification model and on the obtained data. The control unit is then arranged to control the feed motor 130 based on the determined drill bit force F. Advantageously, the automatic feeding can be more precise if the control unit receives feedback of the current drill bit force, since this creates a feedback loop for control of the automatic feeding. Furthermore, the control unit may be arranged to control the feed motor 130 such that the drill bit force F applied to the core drill bit is below a predetermined maximum force. This way, the drilling operation can automatically be controlled in a safe manner. The predetermined maximum force may be obtained from, e.g., manual input or a remote server. The maximum force may be different for different material compositions. If the drill bit force is too large, the drill motor may not be capable of rotating the drill bit due to a too large resistance. Some drilling machines comprises protection means for such scenarios.

For example, the drilling machine can start to pulse the drill motor if the resistance is too large. If the core drill system is manually operated, the operator will notice the pulsing behavior and reduce the drill bit force. Therefore, it is also possible for the feed unit 100 to detect and classify such behavior.

The feed motor 130 is preferably an electrical motor that can be powered from an electrical energy storage device, such as a battery or a super-capacitor, or from electrical mains. Thus, according to aspects, the automatic drill unit comprises an electrical storage system, wherein the feed motor 130 and the control unit 110 are arranged to be powered by the electrical storage system. Preferably, the feed motor 130, the control unit 110, and possibly also the optional energy storage device, are integrally formed and enclosed by a common casing. The feed motor may, alternatively or in combination of, be powered from electrical mains via cable.

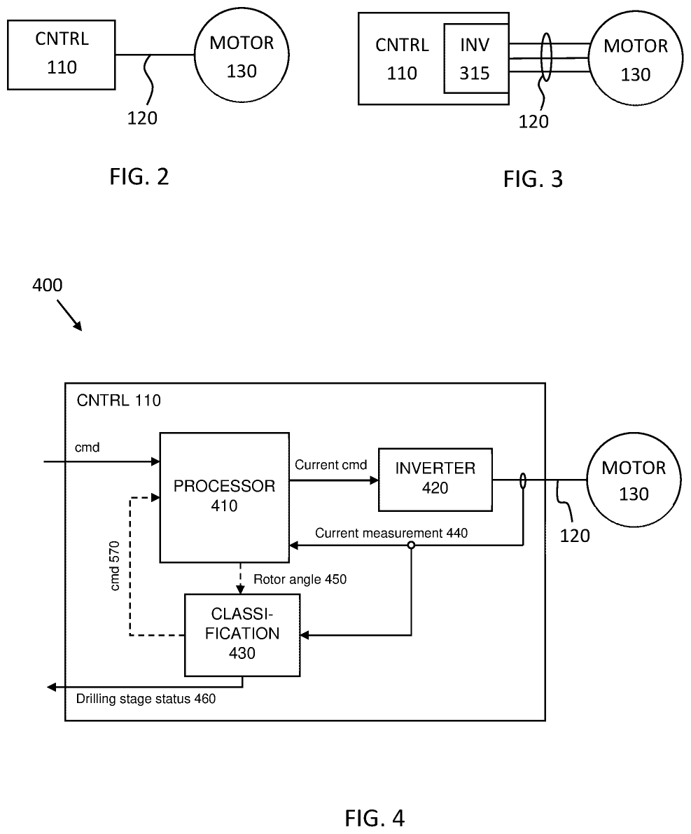

With reference again to FIG. 1, the feed motor is controlled by a control unit 110 via a motor control interface 120. This is also schematically shown in FIG. 2 and in FIG. 3. The motor interface may vary in function and physical realization, but the control unit 110 controls electric motor speed over the interface, and may both accelerate and decelerate, i.e., brake, the feed motor via the motor interface 120.

The motor is preferably a permanent magnet synchronous motor (PMSM) which is an alternating current (AC) synchronous motor whose field excitation is provided by permanent magnets, and which has a sinusoidal counter-electromotive force (counter EMF) waveform, also known as back electromotive force (back EMF) waveform. PMSM motors are known in general and will therefore not be discussed in more detail herein. For instance, similar electrical motors including associated control methods are discussed in “Electric Motors and Drives” (Fifth Edition), Elsevier, ISBN 978-0-08-102615-1, 2019, by Austin Hughes and Bill Drury.

The motor 130 may be a three-phase motor as schematically shown in FIG. 3. In this case the motor interface 120 comprises three wires for energizing the motor windings. The wires are fed from an inverter 315 which is normally controlled by a current command from the control unit 110. An inverter is a module which generates one or more phases of alternating current, normally from a DC feed. By controlling the frequency and voltage of the phases over the motor interface 120, the electromagnetic field in the motor can be brought into a controlled rotation to generate a positive torque by the motor shaft. The electric motor can also be used to provide negative torque to the motor shaft.

It has been realized that the control signals by which the control unit controls the electric motor, i.e., the currents (or voltages) drawn by the electric motor 130 over the motor interface 120, and state variables of the control unit 110 for the motor control comprise valuable information which can be used for indicating different drilling stages in a drilling operation. The control signals and internal parameters of the electric motor and its control system can be monitored, and different types of classification algorithms can be used to indicate the different drilling stages in the drilling operation and/or the material currently engaged by the drill bit. For instance, the currents over the motor interface 120 can be used to detect one or more of the above-mentioned drilling stages and/or materials engaged by the drill bit, such as the startup drilling stage. Internal regulator variables, such as internal state variables of a PID regulator or the like, executed by the control unit 110, can also be used to indicate drilling stages and/or which material that is currently engaged by the core drill bit.

The classification mechanisms are advantageously based on machine learning techniques. Different types of machine learning techniques have been applied with success, but it has been found that algorithms based on random forest techniques are particularly effective and provide robust classification. Various types of neural networks may also be applied with success to this classification task.

Random forests or random decision forests represent an ensemble learning method for classification, regression and other tasks that operate by constructing a multitude of decision trees at training time and outputting the class that is the mode of the classes (classification) or mean/average prediction (regression) of the individual trees. Random decision forests are associated with the advantage of being able to correct for decision trees' habit of overfitting to their training set. Random forests generally outperform decision tree-based algorithms.

As an alternative to random forest classification methods, a less complex decision tree algorithm can be used, often referred to as regression tree algorithms, which is basically a single tree random forest algorithm.

The machine learning techniques used herein comprise the construction of a classification model which can be configured, i.e., “trained”, using a one or more core drills which have experienced various drilling stages and/or encountered different materials. Measurement data of one or more parameters related to the operation of the electric motor of the core drill is stored and tagged with a respective drilling stage, which data is then used to train the classification model in a training phase. The thus configured classification model can then be fed by measurement data in real-time during operation of a core drill. If the core drill experiences a drilling stage similar to one or more of the training examples, then the classification model is likely to classify the core drill as being in that drilling stage. The same holds for a given material encountered by the core drill bit.

Training of a machine learning model for drilling stage classification and/or material classification is advantageously done using a hold-out dataset, where one part of the data set is used to train the model, and another part is used for verification of the trained model.

As an alternative to using machine learning and artificial intelligence, the computer implemented classification model may also be constructed using more straight forward techniques, such as look-up tables and/or thresholding of predetermined statistical measures derived from the obtained data.

FIG. 4 shows a functional view of an example classification system for use with a core drill system 190. A command is obtained, e.g., from a start button on the feed unit 100, or from user configuration of the power tool. The command is input to a processor 410 which will be discussed in more detail below in connection to FIG. 10. The processor 410 converts the command into a current command which is sent to an inverter 420, which in turn controls the electric motor 130 via the motor interface 120. In case the motor 130 is a three-phase motor, the control interface 120 comprises three wires with respective phases.

A current measurement 440 taken in connection to the motor interface 120 is fed back to the processor 410, whereby a closed loop motor control system is formed. As part of this closed loop control system, the processor 410 optionally maintains an estimate of rotor angle 450 of the feed motor 130. There are many known ways to estimate rotor angle in an electric machine, e.g., based on the current measurements on the motor interface 120. For instance, in “Electric Motors and Drives” (Fifth Edition), Elsevier, ISBN 978-0-08-102615-1, 2019, Austin Hughes and Bill Drury discuss the topic at length. An estimate of motor speed can be obtained by differentiating the rotor angle 450 with respect to time.

According to an example, the control unit 110 is arranged to determine an angular position of a rotor of the electric motor, i.e., a rotor angle, based on data indicative of a rotor flux angle of the electric motor, and to obtain the data indicative of angular velocity as a difference of the rotor angular position over time, i.e., a time derivative or time difference value. The control unit 110 may, for instance, be arranged to obtain the data indicative of the rotor flux angle of the electric motor based on a measured current over the control interface 120 or based on a measured or otherwise determined counter electromagnetic force (EMF) associated with the electric motor 130. To improve the estimate of both rotor position and velocity, filtering can be applied to reduce measurement noise. Such filtering may comprise, e.g., normal low-pass filtering or more advanced filtering techniques such as Kalman filtering and the like. However, too much noise suppressing filtering may increase detection delay which is undesired.

A classification analysis unit 430 is arranged to receive measurements of current taken over the motor interface 120, and to determine a current drilling stage of the core drill system and/or a material currently engaged by the core drill bit based on the above-mentioned machine learning techniques. The classification module 430 sends a command 570 to the processor 410 to control the feed motor 130 based on the determined drilling stage. The current drilling stage and/or material currently engaged by the core drill bit may also be communicated by means of an output signal 460.

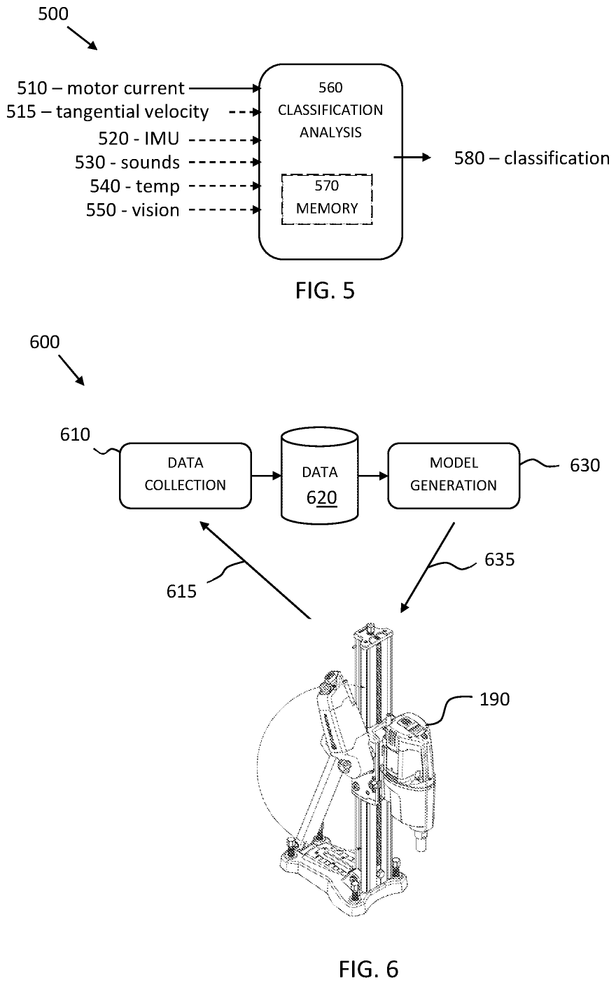

FIG. 5 illustrates a more general classification system 500 according to the teachings herein. The system 500 is arranged to monitor various signals and internal states 510-550 of the core drill system 190 and process these signals by a classification module 560, which may comprise a random forest machine learning algorithm, or a neural network as discussed above. The classification analysis system 500 may optionally, as will be discussed in more detail below, comprise a memory device 570 arranged to store monitored parameter values and states of the core drill system 190. The classification system 500 then outputs a current drilling stage signal 580 and/or data indicative of the material which is currently engaged by the core drill bit.

The classification model used by the classification module 560 may as discussed above use various parameters 510 associated with the electric feed motor, such as drawn current by the motor on the different motor phases. However, classification performance may be improved if additional sensor input signals are also used in combination with the electric motor parameter measurements. An example additional sensor can be any of a sound sensor, an angular rate sensor, an inertial measurement unit (IMU), a temperature sensor, and a vision-based sensor.

Signals 520 from one or more IMUs attached to the feed unit 100 and/or any other place in the core drill system may be used to pick up vibration patterns which may be indicative of one or more drilling stages and/or of the material currently engaged by the core drill bit. For instance, the completion drilling stage when the cire drill bit starts to engage air may give rise to a distinct signature vibration pattern which can be picked up by the machine learning technique and used for classification of the current drilling stage. Therefore, the obtained data may further comprise measured vibration of the feed unit 100, and such vibration can be measured by an inertial measurement unit, IMU, comprised in the feed unit 100.

In another example, the obtained data further comprises sound measured around the feed unit 100, and such sounds are measured by an acoustic sensor comprised in the feed unit 100. In yet another example, a tangential velocity V associated with the drill bit is measured by an angular rate sensor comprised in the feed unit 100.

Temperature sensors and vision sensors arranged in connection to key components in the core drill system may also provide valuable information 540, 550 which allows the machine learning algorithm to pick up patterns in the measurement data which is indicative of a given drilling stage and/or material currently engaged by the core drill bit.

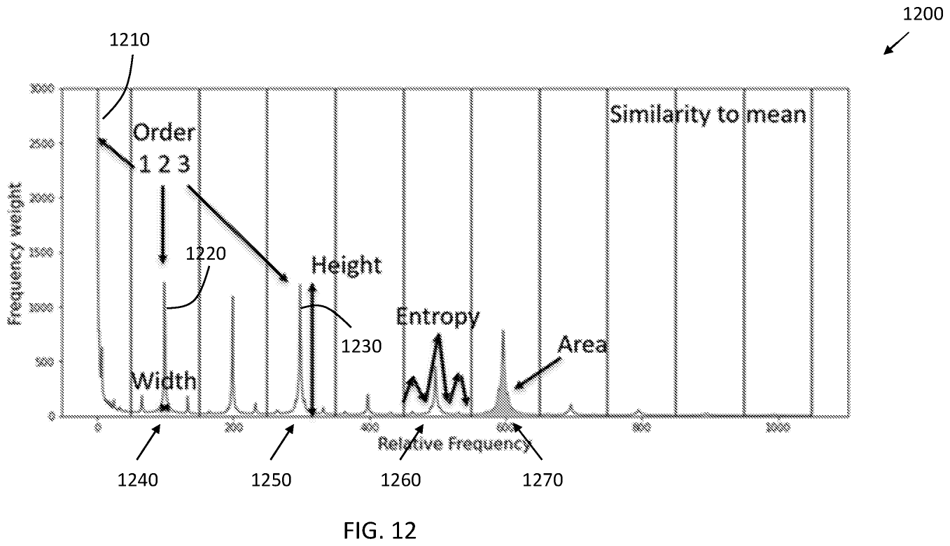

Conceptually, the herein disclosed apparatuses and methods are based on measuring one or more operating parameters associated with the electric motor, such as the current drawn by the motor over the motor interface 120, the relative phases of these currents, and their amplitudes. Various transforms of the motor currents can also be used with advantage, such as a D-Q transformed current. Various transforms may advantageously also be used for other obtained data as well, e.g., data relating to sound, an angular velocity, vibrations, temperature, and vision. As will be discussed below in connection to FIG. 12, Fourier transforms, or wavelet transforms, or the like can also be used with advantage to classify the current drilling stage and/or material currently engaged by the core drill bit. Thus, according to some aspects, the obtained data comprises D-Q transformed motor currents of the feed motor 130, which may be transformed using a Fourier transform, a Wavelet transform, or some other type of frequency-domain based transform.

FIG. 12 shows an example of some types of meta data that can be generated from components of the D-Q transformed motor current. One such form of meta data on which the classification models can be trained and then executed for current drilling stage classification and/or classification of the material currently engaged by the core drill bit is the order of the say three peaks with highest magnitude. In the example, the highest peak 1210 occurs at DC, i.e., zero Hertz relative frequency. The second-most peak in terms of magnitude is the fourth peak 1230 followed by the second peak 1220. It has been found that this order of the peaks in terms of magnitude is indicative of various conditions of the core drill system. The magnitude or height (power) 1250 and the width (frequency bandwidth) 1240 of the frequency peaks in the spectrum are also indicative of certain conditions and therefore represent valuable input to the classifier algorithm. The area, i.e., the energy, 1270 in a sub-band associated with a frequency peak is also of interest, as well as the entropy 1260, which is indicative of how much the peak moves around and changes shape. Various measures of entropy may be defined, one example is a variance of the frequency bin magnitudes over a sub-band associated with a frequency peak. This type of analysis may also be valuable for other obtained data as well, e.g., data relating to sound, an angular velocity, vibrations, temperature, and vision.

This type of meta-data can be used to configure the classification model, optionally for a particular type of tool (e.g. particular type of drill bit), or even for a given individual tool. Data measured under different verified drilling stages is one type of valuable input during this training. Data measured for different verified materials currently engaged by the core drill bit is another type of valuable input during this training. This type of meta data can also be continuously stored by the power tool during operation in the memory module 1030. This stored data can then be off-loaded and used to refine the classification models.

To summarize, according to aspects, the obtained data comprises D-Q transformed motor currents of the feed motor 130, wherein the D-Q transformed motor currents of the obtained data comprises any of frequency width, relative magnitude, frequency sub-band power, and frequency sub-band entropy of a Fourier transformed representation 1200.

Optionally, a sample or window size of the Fourier transform can be selected in dependence of a motor speed of the feed motor 130. This means that the peak locations in terms of relative frequency remains at the same place independently of motor speed, which is an advantage. The ideal sample size for the Fourier transform (or wavelet transform or similar), may be obtained from a look-up table or other function indexed by motor speed. This look-up table or function can be pre-determined by laboratory experimentation and/or determined from analytical analysis.

Optionally, the obtained data comprises one or more state variables of an electric motor regulator module, such as the internal state of a PID regulator or Kalman filter, or the like, configured to regulate and control the operation of the feed motor 130. The obtained data may also comprise an estimated rotor angle 450 of the feed motor. The rotor angle is indicative of, e.g., sudden changes in tool rotational velocity, jerky motion by the cutting tool, and the like.

Obtained data values may be comprised in time domain or in frequency domain, or in some other domain such as a wavelet domain. A combination of different domain signals can also be used, such as a combination of time domain and frequency domain signals.

According to some aspects, the classification model is based on a random forest ensemble learning method, of which a regression tree is a special case with only one tree. According to some other aspects, the classification model is based on a neural network. Both random forest algorithms and neural networks are generally known and will therefore not be discussed in more detail herein.

The classification model may be configured in dependence of a particular type of core drill system 190 e.g., a particular model of a core drill machine, a drill stand 194, or drill bit. The particular type can be a given individual tool, e.g., an individual drill bit. The same classification model can be used for more than one type of tool but be configured differently for the different types of tools. By parameterizing the classification model in dependence of the type of tool, the classification capability of the classification model may be improved, at least in part since there is likely to be a larger set of data to use during initial training of the classification model.

It is understood that the classification model is first initially trained using recorded values of obtained data corresponding to different drilling stages of the core drill system 190 in the pre-determined set of drilling stages. This initial training need not, however, be performed by the control unit 110 during operation of the power tool, although this is certainly an option. It is preferred that this initial training is done off-line, e.g., in a lab or test facility. The training may be performed using gathered data from a plurality of power tools known to have suffered from one or more identified drilling stages. This data collection methods will be discussed in more detail below in connection to FIG. 6. It is appreciated that similar training mechanisms can be applied for determining the material currently engaged by the core drill bit.

The techniques related to classifying current drilling stage, determining a material currently engaged by the core drill bit (including the detection of when the core drill bit encounters a reinforcement bar material), and detecting fault states is preferably implemented using the types of machine learning techniques discussed above.

However, at least some of the techniques may also be realized using classic signal processing techniques which rely on the determining of one or more parameters based on the obtained data, and the comparing these parameters to a set of predetermined classification criteria.

The parameters which are determined based on the obtained data can, for instance, comprise spectral information derived from the obtained data. FIG. 12 provided some example parameters which can be compared against a set of predetermined ranges or thresholds, from which comparison the classification can be determined. For instance, suppose that the any of the height, entropy or area parameters of a given frequency range exceeds a predetermined classification threshold, then a corresponding classification can be made. The configuration of the thresholds and/or the ranges can be performed by practical experimentation in a controlled environment, such as a laboratory, or by computer simulation. This is a form of training of the computer implemented classification model, and forms part of the herein disclosed techniques.

A magnitude and/or frequency content of captured vibration data and or sound can also be used for the aforementioned purpose of realizing the computer implemented classification model. Thus, it is appreciated that the concept of a computer implemented classification model is to be given a broad interpretation herein.

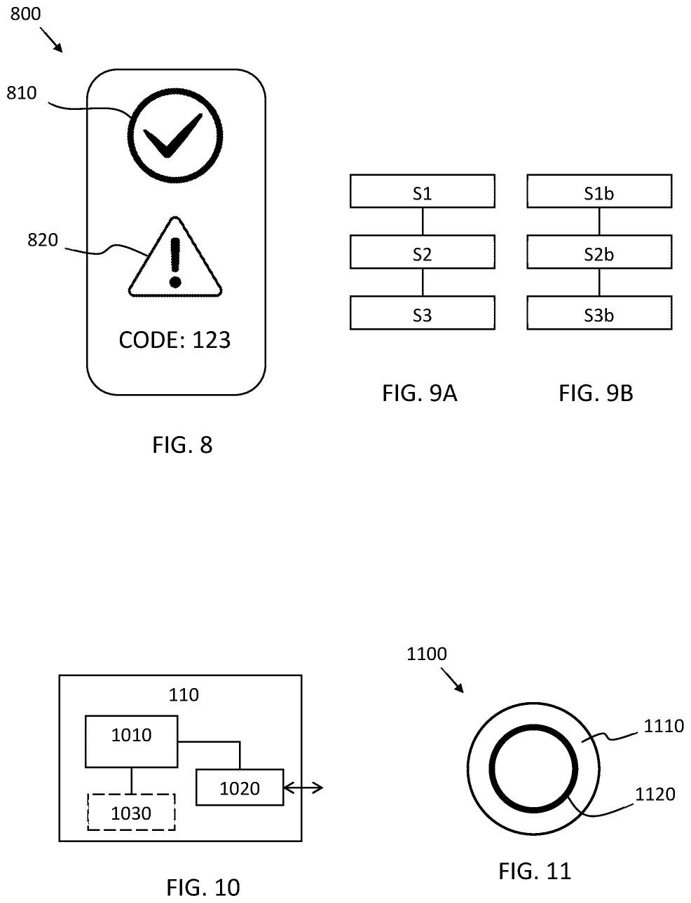

When the control unit 110 controls the feed motor 130 based on the determined drilling stage, the control unit may further notify an operator of the current drilling stage. This can for instance be done by a display such as that illustrated in FIG. 8 which can be integrated with the feed unit 100 and controlled by the control unit 110, or be arranged on a remote control device distanced from the control unit 110. This display 800 may indicate 810 that the power tool is not associated with any abnormal drilling stage. This may, e.g., be a green light symbol. If an abnormal drilling stage is detected, a warning light 820 may be lit. An identification code can also be displayed giving information about the particular drilling stage which has been detected.

The control unit may also notify an operator of the material currently engaged by the core drill bit, i.e., if the core drill bit engages air or some work object material, and optionally also which type of work object material that is being engaged by the core drill bit at the current point in time. This can for instance be done by the display mentioned above. This display may then also indicate if the core drill bit is engaging a material comprised in an expected set of materials, or if some unknown material not previously encountered is currently being engaged by the core drill bit. FIG. 6 illustrates a classification data collection system 600. According to aspects, the control unit is arranged to receive the classification model and/or instructions for controlling the feed motor 130 in dependence of the current drilling stage and/or in dependence of the material currently engaged by the core drill bit from an external entity 630. This can be to configure the feed unit 100 for the first time and/or to replace current model/instructions with updated ones. This means that the classification model used for by the control unit 110 can be regularly updated based on data which has been connected from tools experiencing various drilling stages in the field or based on additional laboratory experiments. The controlling instructions for controlling the feed motor 130 can be how the feeding is controlled based on a particular determined current drilling stage and/or material currently engaged by the core drill bit.

The control unit may further be arranged to transmit any of the obtained data, information indicative of the current drilling stage, information indicative of the material currently engaged by the core drill bit and the current controlling of the feed motor 130 to a data collection entity 610 arranged external to the feed unit 100. In other words, all data gathered by the feed unit (e.g. currents), the results of the classification, and the resulting control of the feed motor are transmitted to the data collection entity 610.

The data collection entity 610 may be configured to gather data 615, i.e., measurements of various data values. This data can be stored in a database 620 from which various classification models for detecting different types of drilling stages and/or materials currently engaged by the core drill bit can be trained. The updated classification models 635 can then be downloaded onto the automating feed unit 100, which then obtain updated models and therefore further improved classification performance.

The external entity 640, the data collection entity 610, the database 620 may be comprised in a single unit, such as a remote server 150. According to some aspects, the feed unit 100 is communicatively coupled to the remote server 150 via wireless link 151. The connection to the remote server 150 may, e.g., be realized as a cellular communications link to a radio base station and then onwards over a wired data communications network such as the Internet. A Wi-Fi link based on, e.g., the IEEE 802.11 family of standards may also be used. Bluetooth and infrared communications are also viable options. Of course, the control unit 110 may also comprise a cellular transceiver configured to access a communications network such as the fourth generation (4G) or fifth generation (5G) communications networks defined by the third generation partnership program (3GPP). A wired connection from the control unit 110 to the remote server 150 is also possible. This wired connection may, e.g., be realized by a USB connection or Ethernet connection, perhaps to an external modem or network.

To facilitate, e.g., a data collection system such as the data collection system shown in FIG. 6, obtained data may be stored in a memory module, such as the memory module 1030 discussed below in connection to FIG. 10. This memory module may be a memory device which is possible to off-load via wireless link or a memory device which can be removed from the power tool in order to off-load stored data, such as a secure digital card (SD-card) or the like.

As mentioned, one drilling stage in the pre-determined set of drilling stages can be an abnormal drilling stage. According to aspects, the abnormal drilling stage comprises cutting segment glazing. Upon detecting such conditions, a pressure on the cutting segments may be adjusted to account for the onset of glazing, e.g., by increased a feed rate of the feed motor. In other words, the control unit 110 may control the feed motor 130 in dependence of detected tool glazing.

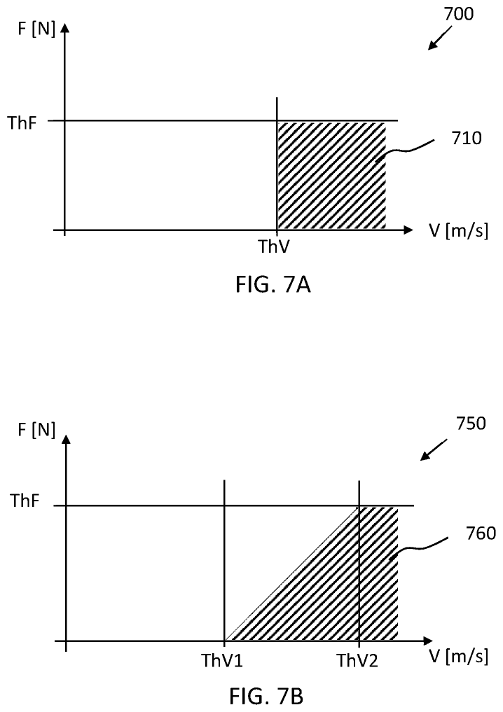

FIGS. 7A and 7B are graphs 700, 750 of tangential velocity V in m/s and applied drill bit pressure F in Newtons.

Glazing refers to an effect where the abrasive cutting segments become dull and stop cutting. Glazing occurs when the cutting segment matrix holding the abrasive particles overheat and cover the abrading particles, i.e., the diamonds. The risk of glazing is a function of the applied drill bit pressure or force F and the tangential velocity V of the cutting segments. In particular, the risk of glazing increases if the drill bit is operated at high tangential velocity and low drill bit pressure. With higher drill bit pressure, a larger tangential velocity can normally be tolerated and vice versa. This means that there is an undesired operating region 710, 760 where the risk of glazing is increased. The size and shape of this undesired operating region depends on the type of cutting segment an on the material to be cut.

FIG. 7A illustrates an example 700 where the undesired operating region 710 is determined by two thresholds: a velocity threshold ThV and a force threshold ThF. In this case it is not desired to operate the core drilling machine for prolonged periods of time above ThV and below ThF. In case a tangential velocity above ThV is desired, then the drill bit force F should be increased to a value above ThF.

FIG. 7B illustrates another example 750 where the undesired operating region 760 starts at a first tangential velocity value ThV1 where the corresponding undesired drill bit applied force F increases gradually up to a threshold value ThF at a corresponding tangential velocity value ThV2.

In general, the thresholds and shape of the undesired operating region may vary with the type of cutting segment, and the type of material to be cut. The undesired operating region may also depend on the type of cooling used, such as the amount of water added during the drilling process.

To summarize, according to aspects, the control unit 110 is arranged to control the feed motor 130 based on the tangential velocity associated with the drill bit. According to further aspects, the control unit 110 is arranged to control the feed motor 130 also based on the drill bit applied force. In this case, the classification model is configured to classify a drill bit force F of the core drill based on obtained data, and the control unit 110 is arranged to determine a drill bit force F based on the classification model and the obtained data. The tangential velocity associated with the drill bit may be obtained from the classification model like the drill bit force. However, it may alternatively be obtained by an angular rate sensor comprised in the feed unit 100. It may also be obtained from manual input or the like, where the tangential velocity is assumed to be more or less constant during the drilling operation.

This way, the risk of glazing can be reduced, by, e.g., automatically controlling the drilling machine to operate at a combination of applied drill pressure F and tangential velocity V where the risk of glazing is at an acceptable level, i.e., outside of an undesired operating region 710, 760. Different types of cutting segments are associated with different ranges of applied drill bit pressure and tangential velocity where there is a risk of glazing. These ranges, or information relating to these ranges, may according to some aspects be obtained from the remote server 150 where tables of properties associated with different types of cutting segments may be stored.

In an example, the feed unit 100 is first configured by the control unit 110 with, e.g., a given drill rate and then started, whereupon it automatically performs the drilling operation. The feed unit, and/or the control unit 110, is arranged to avoid operating the drilling machine at combinations of tangential velocity and pressure where there is a risk of glazing, such as in the undesired operating regions 710, 760. The avoiding can be realized by, e.g., increasing drill bit pressure F to accommodate the configured rotational velocity of the machine.

The feed unit 100 may furthermore comprise a radio frequency identification (RFID) reader. In this case the control unit 110 can be arranged to obtain information via the scanning of an RFID device in the core drill system. The device can be arranged in connection to the mounting point 195 (see FIG. 1) such that the feed unit can read the device when it is attached to the core drill system. However, any part in the core drill system 190 may comprise RFID devices that can be read by the RFID reader on the feed unit 100 by, e.g., manually bringing that part into the vicinity of the reader.

Upon receiving some identification of the type of tool or individual tool via the RFID reader, the control unit can obtain information such as drill bit dimensions, drill bit inertia, drill stand dimensions, drilling machine dimension, drilling machine tangential velocity settings etc. This information can be obtained from the memory module in the feed unit 100. According to another example, such information may be stored on a remote server and the control unit 110 can be arranged the information via a radio transceiver. Of course, the information can also be manually input to the control unit 110.

The tools may also comprise other means for identifying, e.g., the type of tool. Such means for identification may comprise optically readable tags such as QR-codes, or punch-card like symbols which can be read optically and used to index a database on, e.g., the remote server, to obtain the data indicative of the tool diameter or tool inertia.

With reference to the flow chart in FIG. 9A, there is also disclosed a method for controlling a feed unit 100 for feeding a core drill bit of a core drill system 190 into a work object. The feed unit comprises a feed motor 130 and a control unit 110. The feed motor 130 is arranged to be connected to a device 194, 196 for feeding the core drill bit into the work object, and to be controlled by the control unit 110 via a motor control interface 120. The method comprises obtaining S1 a computer implemented classification model, wherein the classification model is configured to classify a drilling stage of the core drill system 190 into a pre-determined set of drilling stages based on obtained data associated with the motor control interface 120, wherein the obtained data is indicative of a current and/or a voltage of the control interface 120, determining S2 a current drilling stage of the core drill system 190 based on the classification model and the obtained data, and controlling S3 the feed motor 130 based on the determined drilling stage.

With reference to the flow chart in FIG. 9B, there is furthermore disclosed herein a method for controlling a feed unit 100 for feeding a core drill bit of a core drill system 190 into a work object. The feed unit comprises a feed motor 130 and a control unit 110. The feed motor 130 is arranged to be connected to a device 194, 196 for feeding the core drill bit into the work object, and to be controlled by the control unit 110 via a motor control interface 120. The method comprises obtaining S1b a computer implemented classification model, wherein the classification model is configured to classify a material currently engaged by the core drill bit into a pre-determined set of materials based on obtained data associated with the motor control interface 120, wherein the obtained data is indicative of a current and/or a voltage of the control interface 120, determining S2b a material currently engaged by the core drill bit based on the classification model and the obtained data, and controlling S3b the feed motor 130 based on the determined drilling stage.

There is also disclosed herein a control unit 110 for a feed unit 100 comprising processing circuitry 1010 configured to execute the method described above. According to aspects, the control unit 110 comprises a storage medium 1030, wherein the storage medium is arranged to store a time history of the obtained data.

FIG. 10 schematically illustrates, in terms of a number of functional units, the general components of the control unit 110. Processing circuitry 1010 is provided using any combination of one or more of a suitable central processing unit CPU, multiprocessor, microcontroller, digital signal processor DSP, etc., capable of executing software instructions stored in a computer program product, e.g., in the form of a storage medium 1030. The processing circuitry 1010 may further be provided as at least one application specific integrated circuit ASIC, or field programmable gate array FPGA.

Particularly, the processing circuitry 1010 is configured to cause the feed unit 100 to perform a set of operations, or steps, such as the methods discussed in connection to FIG. 9A and FIG. 9B and the discussions above. For example, the storage medium 1030 may store the set of operations, and the processing circuitry 1010 may be configured to retrieve the set of operations from the storage medium 1030 to cause the device to perform the set of operations. The set of operations may be provided as a set of executable instructions. Thus, the processing circuitry 1010 is thereby arranged to execute methods as herein disclosed.

The storage medium 1030 may also comprise persistent storage, which, for example, can be any single one or combination of magnetic memory, optical memory, solid state memory or even remotely mounted memory.

The control unit 110 may further comprise an interface 1020 for communications with at least one external device. As such the interface 1020 may comprise one or more transmitters and receivers, comprising analogue and digital components and a suitable number of ports for wireline or wireless communication.

The processing circuitry 1010 controls the general operation of the control unit 110, e.g., by sending data and control signals to the interface 1020 and the storage medium 1030, by receiving data and reports from the interface 1020, and by retrieving data and instructions from the storage medium 1030.

FIG. 11 illustrates a computer readable medium 1110 carrying a computer program comprising program code means 1120 for performing the methods illustrated in FIG. 9A and FIG. 9B, when said program product is run on a computer. The computer readable medium and the code means may together form a computer program product 1100.

1. A feed unit for feeding a core drill bit of a core drill system into a work object, the feed unit comprising a feed motor and a control unit,
wherein the feed motor is arranged to be mechanically connected to a device for feeding the core drill bit into the work object, and to be controlled by the control unit via a motor control interface,
wherein the control unit is arranged to obtain a computer implemented classification model configured to classify a material currently engaged by the core drill bit into a pre-determined set of materials, based on obtained data associated with the motor control interface and/or based on data obtained from one or more sensors arranged in connection to the feed unit,
wherein the control unit is arranged to determine a material currently engaged by the core drill bit based on the classification model and based on the obtained data, and to control the feed motor based on the determined material currently engaged.

2. The feed unit according to claim 1, wherein the pre-determined set of materials comprises air and one or more work object materials.

3. The feed unit according to claim 1, wherein the pre-determined set of materials comprises one or more different work object material compositions and/or levels of concrete maturity.

4. The feed unit according to claim 3, wherein the computer implemented classification model is configured to classify a material composition of the work object into a pre-determined set of material compositions based on the obtained data, wherein the control unit is arranged to determine a material composition of the work object based on the classification model and the obtained data, and to control the feed motor based on the determined material composition.

5. The feed unit according to claim 1, wherein the pre-determined set of materials comprises a metal reinforcement bar material.

6. The feed unit according to claim 5, wherein the control unit is arranged control the feed motor by adjusting a pressure on the core drill bit in response to detecting that the core drill bit has engaged a metal reinforcement bar material.

7. The feed unit according to claim 1, wherein the control unit is arranged to communicate with a remote control device, and to control the feed motor based at least in part on control commands received from the remote control device.

8. The feed unit according to claim 7, wherein the control unit is arranged to transmit data indicative of the material currently engaged by the core drill bit to the remote control device.

9. The feed unit according to claim 1, wherein the classification model is furthermore configured to classify a current drilling stage of the core drill system into a pre-determined set of drilling stages based on obtained data associated with the motor control interface, wherein the control unit is arranged to determine a current drilling stage of the core drill system based on the classification model and on the obtained data, and to control the feed motor based on the determined drilling stage.

10. The feed unit according to claim 1, wherein the computer implemented classification model is arranged to classify a state the core drill system into a pre-determined number of states comprising one or more fault states based on the obtained data, and wherein the control unit is arranged to determine a state of the core drill system out of the pre-determined number of states based on the classification model and on the obtained data, and to control the feed motor based on the determined state.

11. The feed unit according to claim 1, wherein the computer implemented classification model is configured to classify a drill bit force of the core drill based on the obtained data, wherein the control unit is arranged to determine a drill bit force applied to the core drill bit based on the classification model and on the obtained data, and to control the feed motor based on the determined drill bit force.

12. The feed unit according to claim 11, wherein the control unit is arranged to control the feed motor such that the drill bit force applied to the core drill bit is below a predetermined maximum force.

13. The feed unit according to claim 1, wherein the control unit is arranged to control the feed motor at least partly based on a tangential velocity associated with the drill bit.

14. The feed unit according to claim 1, wherein the obtained data further comprises a measured vibration of the feed unit, wherein the vibration is measured by an inertial measurement unit, IMU, comprised in the feed unit.

15. The feed unit according to claim 1, wherein the obtained data further comprises sound measured around the feed unit, wherein the sound is measured by an acoustic sensor comprised in the feed unit.

16. The feed unit according to any previous claim 1, wherein the control unit is arranged to transmit any of the obtained data, information indicative of the material currently engaged by the core drill bit, information indicative of the current drilling stage, and the current controlling of the feed motor to a data collection entity arranged external to the feed unit and/or to a remote control device.

17. The feed unit according to claim 1, wherein the obtained data comprises D-Q transformed motor currents of the feed motor.

18. The feed unit according to claim 1, arranged to control an amount of water added during the grinding process in dependence of the material currently engaged by the core drill bit and/or in dependence of the current drilling stage of the core drill system.

19-49. (canceled)

50. A method for controlling a feed unit for feeding a core drill bit of a core drill system into a work object, the feed unit comprising a feed motor and a control unit, wherein the feed motor is arranged to be connected to a device for feeding the core drill bit into the work object, and to be controlled by the control unit via a motor control interface,
wherein the method comprises:
obtaining a computer implemented classification model, wherein the classification model is configured to classify a material currently engaged by the core drill bit into a pre-determined set of materials based on obtained data associated with the motor control interface and/or based on data obtained from one or more sensors arranged in connection to the feed unit,
determining a material currently engaged by the core drill bit based on the classification model and the obtained data, and
controlling the feed motor based on the determined material.

51-54. (canceled)

55. A concrete processing system comprising a core drill system and a remote control device,
the core drill system comprising a feed unit with a feed motor and a control unit wherein the feed motor is arranged to be mechanically connected to a device for feeding a core drill bit of the core drill system into a work object, and to be controlled by the control unit via a motor control interface,
wherein the control unit is arranged to communicate with a remote control device and to control the feed motor based at least in part on control commands received from the remote control device,
wherein the control unit is further arranged to determine a material currently engaged by the core drill bit based on a computer implemented classification model and based on obtained data associated with the feed unit,
wherein the control unit is arranged to adjust the control commands received from the remote control device for controlling the feed motor based on the material currently engaged by the core drill bit.
